(19) United States
(12) Patent Application Publication
(10) Pub. No.: US 2011/0049950 A1
(43) Pub. Date: Mar. 3, 2011

(54) Cover

(76) Inventor: Shuan Therese Pereira, Dandenong North (AU)

(21) Appl. No.: 12/868,760

(22) Filed: Aug. 26, 2010

(30) Foreign Application Priority Data
Aug. 26, 2009 (AU) 2009904076

(51) Int. Cl. A47C 31/11; A47C 31/00; B60R 22/12; B60R 22/00; B60R 22/10

(52) U.S. Cl. 297/219.12; 297/219.1; 297/482

(57) ABSTRACT

A cover for a seat and a safety harness, the safety harness including a pair of shoulder belts, a pair of lap belts, and at least one anti-submarine belt, the seat cover comprising,
a first pair of shoulder apertures for receiving respective shoulder belts therethrough,
a pair of lap apertures for receiving respective lap belts therethrough, and
an anti-submarine aperture for receiving the at least one anti-submarine belt therethrough.
   wherein the said seat cover is removable, and the said lap and anti-submarine apertures include closing means for substantially preventing the ingress of spillage and/or bodily fluids into the said aperture around a respective lap and/or submarine belt.

### CROSS REFERENCE TO RELATED APPLICATION

This application claims priority to Australian Patent Application 2009904076, filed Aug. 26, 2009, which is hereby incorporated by reference herein as if fully set forth in its entirety.

### FIELD OF THE INVENTION

The invention relates to covers for safety harnesses and/or covers for seats with safety harnesses.

### BACKGROUND OF THE INVENTION

Five point safety harnesses are a particularly safe and secure way of restraining a person within a seat in a moving vehicle. For example, five point safety harnesses are commonly used by race car drivers, being attached to a support frame behind the race car seat, and for young children, being attached to a child safety seat which can be mounted on the seat of a car. Other items such as prams, strollers, high chairs and wheelchairs may also use a five point harness.

As is well known children, can be very messy at times, meaning that food, drink and saliva can be dribbled and spilt on to the seat and harness belts. Moreover young children may chew on the straps of the harness. Thus the seat or harness can be easily soiled, damaged or stained.

Many harnesses are difficult or not possible to remove and clean. Young children have a propensity of chewing and sucking on objects in their vicinity. The risk of disease is therefore increased if a child sucks or chews on a soiled harness. Soiled harnesses have another potential negative effect in that it may make it less likely for the parent or guardian to use the soiled harness with their child, as they wish to minimise the risk of the child coming into contact with the harness. Either way, there is increased risk to the child's health, safety and well-being.

Further disadvantages associated with the use of child safety seats may include children scratching themselves on the harness, or unclipping the harness.

Thus it may be advantageous to provide a product that limits, reduces, overcomes, or substantially ameliorates one or more of the aforesaid problems or disadvantages.

### DISCLOSURE OF THE INVENTION

In one aspect the invention provides a cover for a seat and a safety harness, the safety harness including a pair of shoulder belts, a pair of lap belts, and an anti-submarine belt, the seat cover comprising,

a first pair of shoulder apertures for receiving respective shoulder belts therethrough,

a pair of lap apertures for receiving respective lap belts therethrough, and

an anti-submarine aperture for receiving the anti-submarine belt therethrough.

The seat may make up part of a high chair, car seat, child safety seat, wheelchair, or rehabilitation chair, or any other device utilising a harness.

The seat cover may be removable and the lap and anti-submarine apertures include closing means for substantially preventing the ingress of spillage and/or bodily fluids into the aperture around a respective lap and/or submarine belt.

The seat cover may comprise closing means for substantially preventing the ingress of spillage and/or bodily fluids into the said apertures around a respective shoulder belt.

The belts of the safety harness may be attached to the seat or to a frame to which the seat is affixed.

In an alternative embodiment the closing means is further adapted to close off the shoulder apertures around their respective belts.

The seat cover may comprise more than one pair of shoulder apertures. For instance, there may be a second pair of shoulder apertures located above or below the said first pair of shoulder apertures, thereby allowing the seat cover to be suitably fitted on various seats, each of which may have a pair of shoulder belts beginning at a different height or level, and/or making the cover more adaptable and adjustable to suit the needs of a growing child.

Preferably the closing means comprises an elastic band adapted to recoil and substantially close off its respective aperture.

Preferably the closing means is incorporated into a sleeve that projects out from the cover away from the seat in use, and the elastic band may line the sleeve.

Preferably the seat cover includes three sleeves projecting out from the cover away from the seat in use that accommodate the anti-submarine and lap apertures.

Preferably the seat cover comprises additional sleeves projecting out of the cover away from the seat that accommodate the shoulder apertures.

Preferably the sleeve comprises a tubular shape.

Preferably the sleeve includes fastening means for joining ends or edges of the sleeve to form the tubular shape.

Preferably when the said fastening means are unfastened, this enables the separation of the ends, or edges, of the sleeve which are joined by the sleeve fastener.

Preferably the fastening means comprises a hook and loop type fastener like Velcro™ and/or press studs.

Preferably the seat cover comprises a split extending from a peripheral edge to one of the shoulder, anti-submarine, or lap apertures or sleeves, and the split includes fastening means for releasably closing the split.

Preferably the split fastening means comprises a hook and loop type fastener like Velcro™, and/or press studs.

Preferably the split fastening means is present along the edges of the split, and unfastening the fastening means enables the separation of the split edges and opening of the split.

Preferably the split communicates with, or is continuous with, one of the shoulder, anti-submarine or lap apertures, and when the split fastening means is unfastened it communicates with, or is continuous with, one of the shoulder, anti-submarine or lap apertures when their respective sleeve is unfastened.

Preferably there is a plurality of splits including

a pair of shoulder splits extending from opposite side peripheral edges of the cover to respective shoulder apertures or shoulder sleeves, and/or

a pair of lap splits extending from opposite side peripheral edges of the cover to respective lap apertures or lap sleeves, and/or

an anti-submarine split, extending from a bottom peripheral edge of the cover, to the anti-submarine aperture or sleeve.

Preferably the seat cover includes a notch adapted to accommodate a pillar of the seat, the pillar being for positioning between the legs of an occupant of the seat, wherein the notch is set in from a bottom edge of the seat cover and is adapted to pass around a rear aspect of the base of the said pillar.

Preferably the seat cover is water proof.

Preferably the seat cover comprises padding.

Preferably the seat cover is machine washable and reusable.

Alternatively the seat cover is disposable.

In another aspect of the invention, the present invention provides a cover for a seat and a safety harness, the safety harness comprising a pair of shoulder belts, and a Y-shaped anti-submarine belt, the seat cover comprising,

a pair of shoulder apertures for receiving respective shoulder belts therethrough,

an anti-submarine aperture for receiving the said Y-shaped anti-submarine belt therethrough, and

closing means for closing off the said Y-shaped anti-submarine aperture around the said Y-shaped anti-submarine belt.

The upper arms of the Y-shaped anti-submarine belt are attachable to respective shoulder belts, or are attachable to, or continuous with, a shield which is attachable to the shoulder belts.

In another aspect of the invention, the present invention provides a cover for a seat and a safety harness, the safety harness including a pair of shoulder belts, a pair of lap belts, and at least one anti-submarine belt, and a junction region where the shoulder and/or lap belts connect with anti-submarine belt when the harness is fastened, the safety harness cover comprising,

a pair of shoulder members for enclosing respective shoulder belts along the majority of their length,

a pair of lap members for enclosing respective lap belts along the majority of their length,

an anti-submarine member for enclosing the anti-submarine belt along the majority of its length, and

a junction member for enclosing the junction region.

Preferably each shoulder member comprises, or is adapted to form, a shoulder sleeve, and the shoulder sleeve is adapted to receive the shoulder belt therethrough.

Preferably the shoulder sleeve comprises a tubular shape, and the said shoulder sleeve comprises a shoulder fastening means for joining ends or edges of the sleeve to form a tubular shape. Unfastening the shoulder sleeve fastener enables separation of the ends or edges of the sleeve that are joined by the shoulder sleeve fastener.

Preferably the said shoulder sleeve fastener comprises a hook and loop type fastener like Velcro™ and/or press studs.

Preferably each shoulder member comprises a central strip bordered on each side by a pair of foldable strips, and the said foldable strips are adapted to fold along their borders in front of, or behind, the central strip, and overlap each other, in which position they are releasably fastenable together to create a flat tubular shoulder sleeve.

Preferably the shoulder member may be adapted to enclose a sleeve of the said seat cover when installed in which the said shoulder member forms part of the closing means of the seat cover, being adapted to close off access to one of the shoulder apertures.

Preferably each lap member comprises, or is adapted to form, a lap sleeve, and the lap sleeve is adapted to receive the lap belt therethrough.

Preferably the lap sleeve comprises a tubular shape.

Preferably the lap sleeve includes fastening means for joining ends or edges of the sleeve to form the tubular shape.

Preferably unfastening the lap sleeve fastening means enables the separation of the ends, or edges, of the sleeve which are joined by the said lap sleeve fastener.

Preferably the said sleeve fastener comprises a hook and loop type fastener like Velcro™ and/or press studs.

Preferably each lap member comprises a central strip bordered on each side by a pair of foldable strips, and the foldable strips are adapted to fold along their borders in front of, or behind, the central strip and overlap each other, in which position they may be fastened together to create a flat tubular lap sleeve.

Preferably the lap member is adapted to enclose a sleeve of the seat cover when installed, such that the said lap member forms a part of the closing means of the seat cover, being adapted to substantially close off access to one of the said lap apertures.

Preferably each shoulder belt is connected to a respective lap belt.

Preferably each shoulder member is joined to, or is continuous with, a respective lap member, thereby forming an elongate member, such that the said elongate member comprises the said shoulder member and the said lap member, and the said elongate member is adapted to form an elongate sleeve.

Preferably the said elongate sleeve may be adapted to receive one of the shoulder belts and one of the lap belts therein.

Preferably the elongate sleeve comprises a tubular shape.

Preferably the elongate sleeve has fastening means for joining ends or edges of the elongate sleeve to form a tubular shape, and the unfastening of the said elongate sleeve fastener enables the separation of the ends or edges of the sleeve which are joined by the elongate sleeve fastener.

Preferably the elongate sleeve fastening means are a hook and loop type fastener like Velcro™, and or comprises press studs.

Preferably each elongate member comprises a central strip bordered on each side by a pair of foldable strips, and the foldable strips are adapted to fold along their borders in front of or behind the central strip and overlap each other, in which position they are releasably fastenable together to create a flat tubular elongate sleeve.

Preferably the elongate member comprises an opening between the shoulder member and the said lap member, and the opening is adapted to receive the ends of the shoulder and lap belts, or part of a buckle to which those ends are fastened, therethrough the said opening.

Preferably the elongate member comprises a pair of buckle fasteners at the level of the opening which interengage with the harness buckle to retain it in place with respect to the cover, and prevent it from sliding into the said tube, or behind the cover.

Preferably the buckle fasteners include a hook and loop fastener like Velcro™ and/or press studs.

Preferably the anti-submarine member comprises, or is adapted to form, an anti-submarine sleeve, and the said anti-submarine sleeve is adapted to receive the anti-submarine belt therethrough.

Preferably the anti-submarine sleeve comprises a tubular shape.

Preferably the anti-submarine sleeve comprises an anti-submarine sleeve fastener for joining ends, or edges, of the sleeve to form a tubular shape. Unfastening the said anti-submarine sleeve fastener enables the separation of the ends, or edges, of the sleeve that are joined by the anti-submarine sleeve fastener.

Preferably the anti-submarine sleeve fastener may be a hook and loop type fastener like Velcro™, and/or comprises press studs.

Preferably each anti-submarine member comprises a central strip bordered on each side by a pair of foldable strips, and the foldable strips may be adapted to fold along their borders in front of, or behind, the central strip, and overlap each other, in which position they are releasably fastenable together to create a flat tubular anti-submarine sleeve.

Preferably the anti-submarine member is adapted to enclose a sleeve of the seat cover when installed, and therefore the said anti-submarine member forms a part of the closing means of the seat cover, being adapted to substantially close off access to the anti-submarine aperture.

Preferably the junction member comprises a wrap strip adapted to wrap at least partially around the junction region, and the said wrap strip is adapted to wrap at least partially around the junction region when the harness is fastened, thereby the said wrap strip wraps around the bottom ends of respective said shoulder belts, with the remaining portions of the shoulder belts projecting out above the wrapped wrap strip. The wrap strip also wraps around the top ends of respective lap belts, with the remaining portions of the lap belts projecting out below the wrapped wrap strip.

The harness cover as claimed in claim 50 wherein the said wrap strip comprises a strip fastener, and the strip fastener is present at one or both ends of the said strip, and the strip fastener is adapted to hold the said wrap strip wrapped, at least partially around the junction region.

The harness cover as claimed in claim 51 wherein the said anti-submarine member is attachable to, or continuous with, the wrap strip, and the said central strip of the said anti-submarine member is attachable at its top end, to the bottom lengthwise border of the said wrap strip.

Preferably the junction member comprises an overlap segment, and the overlap segment is attachable to, or continuous with, the wrap strip, and an edge of the overlap segment is attachable to the top lengthwise border of the wrap strip, and the overlap segment is adapted to wrap over in front of, or behind, the junction region.

Preferably the overlap segment comprises a segment fastener, and the segment fastener is present at one or both ends of the said overlap segment, and the said segment fastener is adapted to fasten the said overlap segment to one or both ends of the said wrap strip when the wrap strip is wrapped at least partially around the said junction region.

Preferably the overlap segment is adapted for fastening to opposite ends of the said wrap strip.

Preferably the harness cover is removable.

Preferably the harness cover, or parts thereof, are water proof.

Preferably the harness cover, or parts thereof, comprise shock absorbing material and/or padding.

Preferably the harness cover or parts thereof, are washable and reusable.

Alternatively the harness cover, or parts thereof, are disposable.

In another aspect of the invention, the present invention provides a cover for a seat and a safety harness, the safety harness including a pair of shoulder belts, a pair of lap belts, and at least one anti-submarine belt, and a junction region where the shoulder belts connect with anti-submarine belt when the harness is fastened, the safety harness cover comprising,

a pair of shoulder members for enclosing respective shoulder belts along the majority of their length,

an anti-submarine member for enclosing the anti-submarine belt along the majority of its length, and

a junction member for enclosing the junction region,

such that when used in conjunction, the said harness cover and the seat cover may substantially cover the seat and enclose the safety harness, thereby substantially preventing the ingress of spillage, debris and/or bodily fluids on to the seat and safety harness.

In another aspect the invention provides a cover product for a seat with a safety harness, the safety harness comprising a pair of shoulder belts, a pair of lap belts, and an anti-submarine belt, the cover product comprising at least one of the safety harness cover and the seat cover in any of the forms described herein.

In an alternative aspect the invention provides a cover product for a seat with a safety harness, the safety harness comprising a pair of shoulder belts, and an anti-submarine belt, the cover comprising at least one of the safety harness cover and the seat cover in any of the forms described herein.

In another aspect the invention provides a kit of parts for a cover product for a seat with a safety harness, the safety harness comprising a pair of shoulder belts, a pair of lap belts, and an anti-submarine belt, the kit comprising at least one of the safety harness cover and the seat cover in any of the forms described herein.

### BRIEF DESCRIPTION OF THE DRAWINGS

By way of example only, embodiments of the invention are described more fully hereinafter with reference to the accompanying drawings, in which:

FIG. 1 is an axonometric view of a cover product in accordance with the invention shown installed on a safety seat which is restraining a child;

FIG. 2 is a front view of a seat cover of the cover product of FIG. 1;

FIG. 3 is a rear view of the seat cover of FIG. 2;

FIG. 4 is a front view of an elongate member of the cover product of FIG. 1;

FIG. 5 is a rear view of the elongate member of FIG. 4;

FIG. 6 is a front view of a middle piece of the cover product of FIG. 1;

FIG. 7 is a rear view of the middle piece of FIG. 6;

FIG. 8 is an axonometric view illustrating the seat cover of FIG. 2 being installed on the safety seat;

FIG. 9 is an axonometric view showing the seat cover of FIG. 2 installed on the safety seat;

FIG. 10 is an axonometric view illustrating installation of a harness cover of the safety cover product of FIG. 1;

FIG. 11 illustrates how the elongate member of FIG. 4 can be shortened during installation;

FIG. 12 is an axonometric view showing the harness cover installed on the safety seat;

FIG. 13 is a rear view schematic which illustrates how the middle piece of FIG. 6 can be folded and fastened during installation;

FIG. 14 is a rear view of an alternative seat cover in accordance with the invention, with the inset showing a sleeve projecting from the front surface of the alternative seat cover.

### DETAILED DESCRIPTION OF THE DRAWINGS

The various elements identified by integers in the drawings are listed in the following integer list.

### INTEGER LIST

2 Cover product
4 Child safety seat
6 Child
8 Seat cover
10 Harness cover
12 Seat
14 Five point safety harness
16 Shoulder belts
18 Length adjusting element
20 Lap belt
22 Anti-submarine belt
24 Junction clasp
26 Adjustment buckle
28 Loop
30 Head
32 Length adjusting portion
34 Shoulder aperture
36 Lap aperture
38 Anti-submarine aperture
40 Lap sleeve (of seat cover 8)
42 Anti-submarine sleeve (of seat cover 8)
44 Main sheet
46 Elastic band
48 Hooked material
50 Looped material
52 Shoulder split
54 Hooked material
56 Looped material
58 Lap split
60 Hooked material
62 Looped material
64 Pouch
66 Elasticised Strip
68 Elongate sleeve (of harness cover 10)
70 Shoulder portion
72 Lap portion
74 Opening
76 Central strip
78 Foldable strip
80 Foldable strip
82 Hooked material
84 Looped material
88 Middle piece
90 Anti-submarine sleeve (of harness cover 10)
92 Wrap strip
94 Overlap segment
96 Central strip
98 Foldable strip
100 Foldable strip
102 Hooked material
104 Looped material
106 Hooked material
108 Hooked material
110 Looped material
112 Looped material
114 Notch
116 Pillar
118 Arrow
120 Arrow
122 Arrow
124 Arrow
126 Arrow
128 Seat cover
130 Main sheet
132 Pouch
134 Anti-submarine aperture
136 Lap aperture
138 Notch
140 Lap sleeve (of seat cover 128)
142 Elastic band
144 Lower shoulder aperture
146 Upper shoulder aperture
148 Arrow
150 Buckle fastener hook part
152 Buckle fastener hoop part

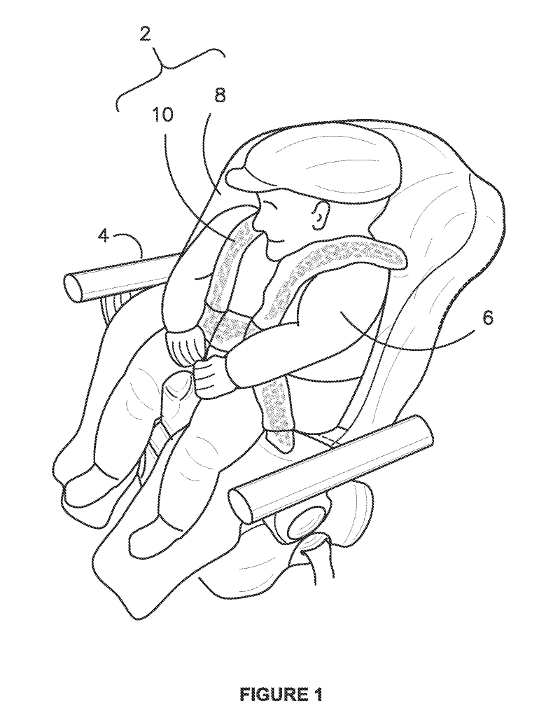

Referring to FIG. 1 there is shown a cover product 2 installed on a child safety seat 4 in which a child 6 is restrained. A cloth version of the cover product 2 is shown in the drawings, which product may be removed, machine washed, and then re-used. The cloth version may be considered suitable because of its hypo-allergenic and environmentally friendly characteristics. However, it is envisaged that other materials may also be suitable in the manufacture of the cover product 2. For instance, a plastic version such as Rexine or plastic backed cotton may be suitable because of its ability to be wiped clean. The plastic version may be preferred in a health-care setting for example.

The cover product 2 comprises a seat cover 8 and a harness cover 10.

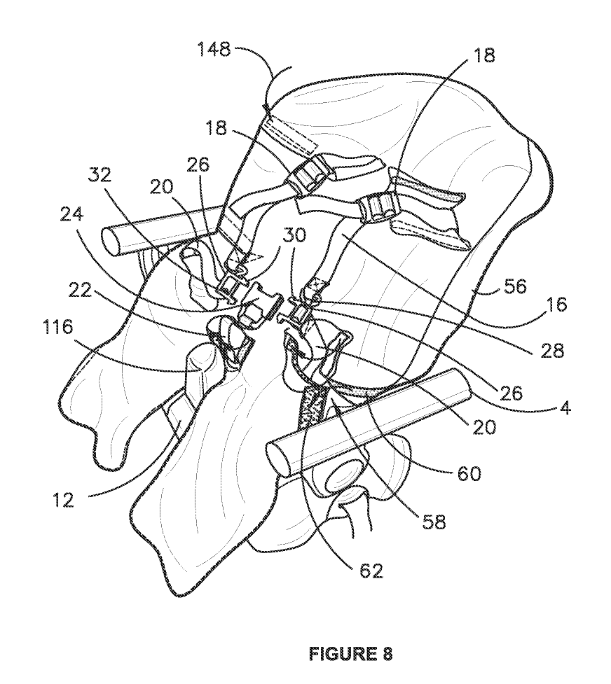

As can be seen in FIG. 8, the child safety seat 4 comprises a seat 12 and a five-point safety harness 14 which is fastened to the seat 12. A pillar 116 projects up from the seat. The five point safety harness 14 comprises a pair of shoulder belts 16 with length adjusting elements 18, a pair of lap belts 20 with adjustment buckles 26 at their outer ends, and an anti-submarine belt 22 with a junction clasp 24 at its outer end. The adjustment buckles 26 each have a loop 28 for receiving one of the shoulder belts, a head 30 for insertion into the junction clasp 24, and a length adjusting portion 32 for adjusting the lap belt 20.

The harness 14 is fastened by threading the outer ends of the shoulder belts through respective loops 28 of the adjustment buckles 26, thereby connecting the shoulder belts with respective lap belts. The heads 30 of the adjustment buckles 26 are then inserted into the junction clasp, thereby connecting the lap and shoulder belts with the anti-submarine belt. Once fastened, the harness 14 is tightened by adjusting the length of the shoulder belts 16 through length adjusting elements 18 and adjusting the length of the lap belts 20 through length adjusting portions 32.

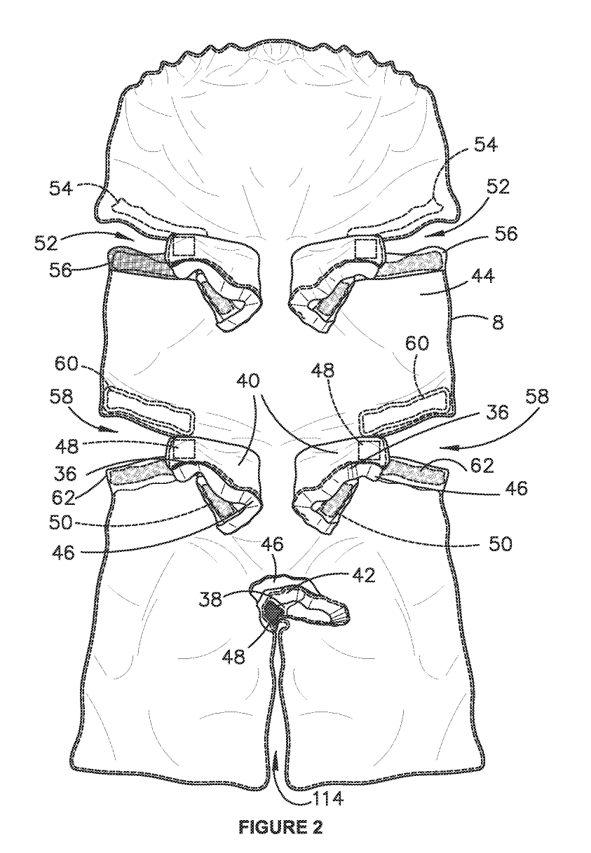

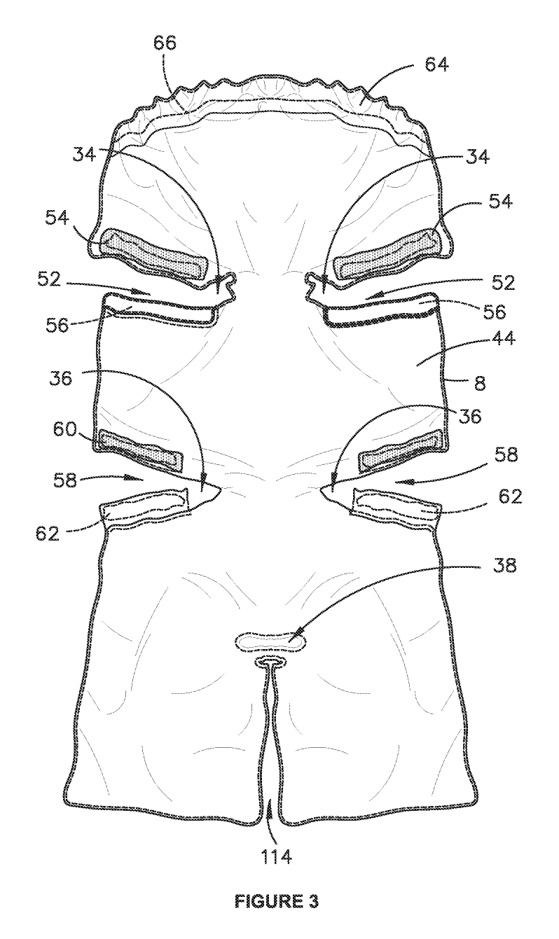

Referring now to FIGS. 2 and 3, the seat cover 8 comprises a main sheet 44 which comprises pair of shoulder apertures 34, a pair of lap apertures 36, and an anti-submarine aperture 38.

The lap apertures 36 open into and through a pair of lap sleeves 40 which are attached along, and project forwardly from, the portions of the main sheet 44 which border the openings into the lap apertures 38. Similarly, the anti-submarine aperture 38 opens into and through an anti-submarine sleeve 42 which is attached along, and projects forwardly from, the portion of the main sheet 44 which borders the opening into the anti-submarine aperture 38.

The outer end of each of the lap and anti-submarine sleeves, 40 and 42 respectively, is lined by an elastic band 46. The elastic bands are themselves formed of an approximately one centimetre wide elasticised strip in the embodiment shown with one side edge of the strip attached along the outer end of the sleeve and the other side edge projecting inwardly therefrom. It is envisaged in alternative embodiments of the invention that the elastic bands may be wider or narrower.

It is envisaged that the elastic band 46 may be omitted in another version of the seat cover which is intended to be used in conjunction with the harness cover 10. In this other version, food access to the apertures which open into and through the sleeves of the seat cover may be blocked by the harness cover 10 which, when fitted, acts to enclose the sleeves of the seat cover, thereby blocking off access thereto (as is described later).

Each of the sleeves, 40 and 42, has a Velcro sleeve fastener having a strip of hooked material 48 attached along one edge of the sleeve 40 and a strip of looped material 50 attached along another edge.

The main sheet 44 further comprises a pair of shoulder splits 52 extending from opposite side edges of the main sheet 44 to respective shoulder apertures 34. Each of the shoulder splits 52 has a Velcro shoulder split fastener having a strip of hooked material 54 attached along the upper surface of the shoulder split 52 facing rearward and a strip of looped material 56 attached along the lower surface of the shoulder split facing forward.

The main sheet 44 also comprises a pair of lap splits 58 extending from opposite side edges of the main sheet 44 to respective lap apertures 36. Each of the lap splits 58 has a Velcro lap split fastener having a strip of hooked material 60 attached along the upper surface of the lap split 58 facing rearward and a strip of looped material 62 attached along the lower surface of the lap split facing forward.

The top region of the main sheet 44 arches rearward to form a shallow pouch 64. An elasticised strip 66 is sewn into the bottom free edge of the pouch 64.

A notch 114 extends in from a bottom edge of the main sheet 44 towards the anti-submarine aperture 38.

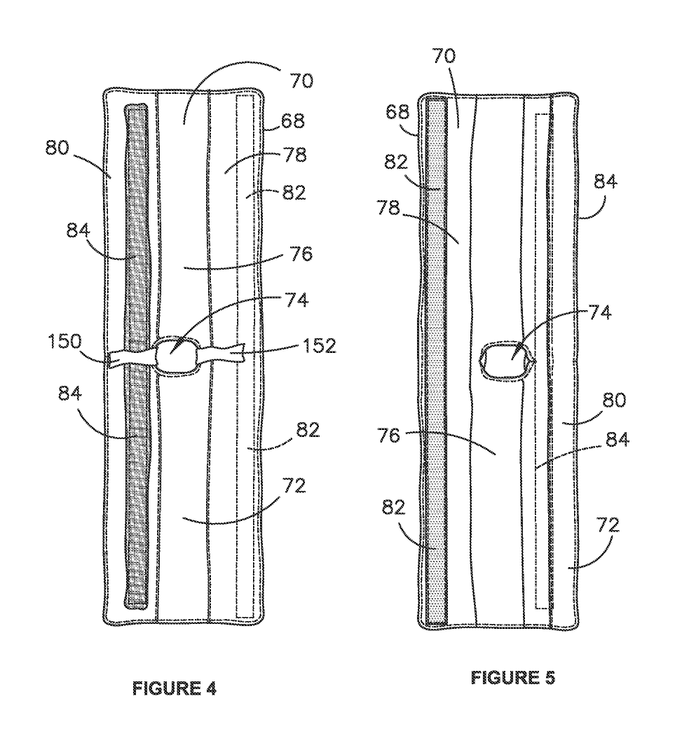

The harness cover 10 comprises a pair of elongate sleeves 68. One of the elongate sleeves 68 is shown unfolded in FIGS. 4 and 5 to form a flat sheet. The top half of the elongate sleeve is divided into a shoulder portion 70 for covering the shoulder belt 16 and the bottom half of the sleeve is divided into a lap portion 72 for covering the lap belt 20. An opening 74 for passage of the adjustment buckle 26 is present between the shoulder and lap portions, 70 and 72 respectively. Optionally a hook and loop buckle fastener 150 and 152 is included. These are looped through the buckle and fastened together. They then combine to retain the buckle in position, and prevent it from slipping into the tube and/or under the cover.

The sheet of the elongate sleeve 68 is divided into a lengthwise central strip 76 bordered on each side by foldable strips 78 & 80. The elongate sleeve comprises a Velcro fastener having a strip of hooked material 82 in each of the shoulder and lap portions, 70 and 72 respectively, on the rear surface along the edge of foldable strip 78. The Velcro fastener also has a strip of looped material 84 in each of the shoulder and lap portions, 70 and 72 respectively, on the front surface of foldable strip 80.

The elongate sleeve 68 shown in FIGS. 4 and 5 has been described with reference to a right sided elongate sleeve which is adapted for covering the shoulder and lap belts, 16 and 20 respectively, which are arranged on the right side when facing the chair. However, as the left sided elongate sleeve is a mirror image of the right sided elongate sleeve, the right sided elongate sleeve shown in FIGS. 4 and 5 could simply be turned upside-down to form a left sided elongate sleeve, with the reference numerals in FIGS. 4 and 5 to be remarked accordingly.

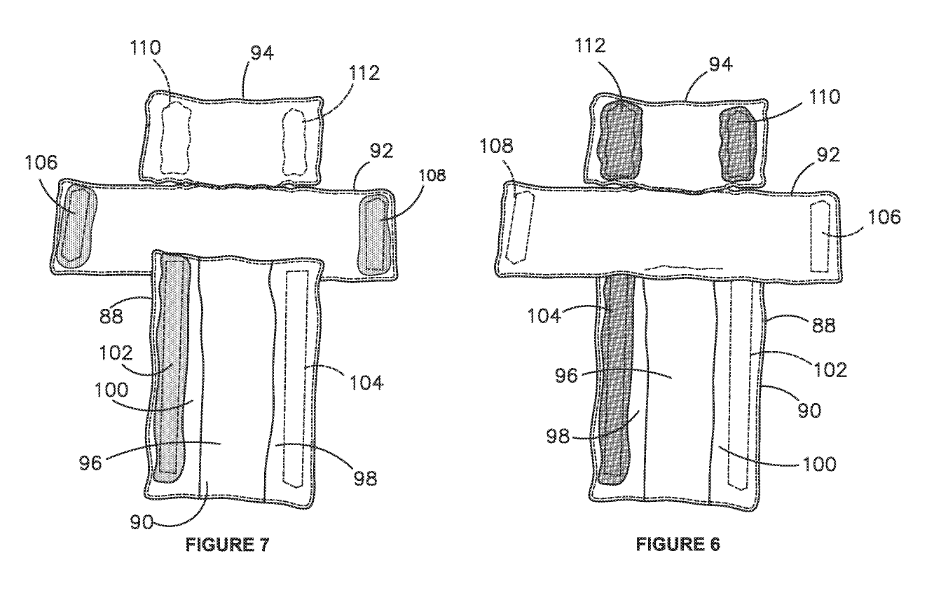

Referring now to FIGS. 6 and 7, the harness cover further comprises a middle piece 88. The middle piece is made up of an anti-submarine sleeve 90, a wrap strip 92, and an overlap segment 94.

The anti-submarine sleeve 90 is shown unfolded in FIGS. 6 and 7 to form a flat sheet. The sheet of the anti-submarine sleeve 90 is divided into a lengthwise central strip 96 bordered on each side by foldable strips 98 & 100. The anti-submarine sleeve comprises a Velcro fastener having a strip of hooked material 102 on the rear surface of foldable strip 100. The Velcro fastener also has a strip of looped material 104 on the front surface of foldable strip 98.

The wrap strip 92 is shown unfolded in FIGS. 6 and 7 to form a flat elongate rectangular strip. The bottom edge lengthwise edge of the wrap strip is stitched to the top edge of the central strip 96 of the anti-submarine sleeve 90. The wrap strip 92 comprises a Velcro fastener having a strip of hooked material 106 on the rear surface along its right edge and another strip of hooked material 108 on the rear surface along its left edge.

The overlap segment 94 is rectangular in shape with the central part of its bottom lengthwise edge being stitched centrally to the top lengthwise edge of the wrap strip 92. The overlap segment 94 comprises a Velcro fastener having a strip of looped material 110 on the rear surface near its right edge and another strip of looped material 112 on the rear surface near its left edge.

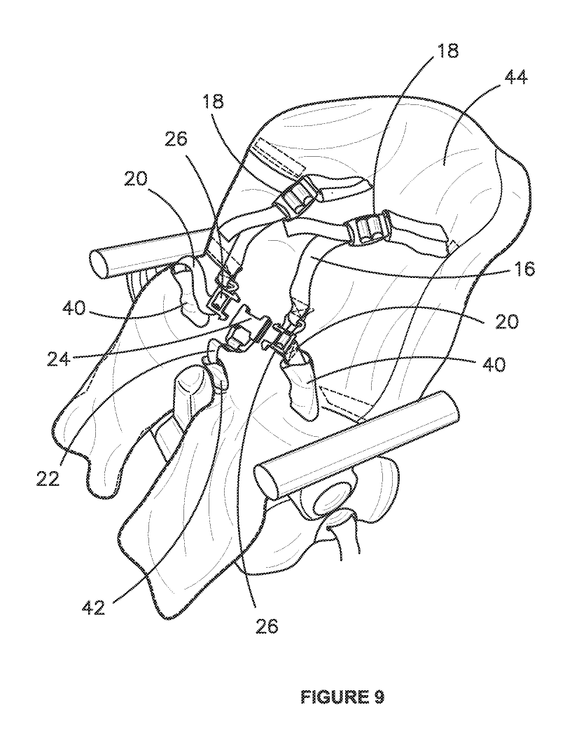

As shown in FIGS. 8 and 9, the seat cover 8 may be fitted on to the seat 12 in the following manner:

Unclip and withdraw the heads 30 of the adjustment buckles 26 from the junction clasp 24, thereby disconnecting the joined lap and shoulder belts, 20 & 16 respectively, from the anti-submarine belt 22.

Unfasten all Velcro fasteners of the seat cover 8.

Hang the shallow pouch 64 of the seat cover 8 over the top of the seat 12.

Thread the anti-submarine belt 2 up through the anti-submarine sleeve 42 so that the junction clasp 24 projects therefrom.

Flatten the main sheet 44 back against the seat 12, with pillar 116 projecting up through notch 114.

Close the anti-submarine sleeve 42 around the anti-submarine belt 2, fastening together hooked and looped portions of the anti-submarine sleeve Velcro fastener, 48 and 50 respectively. The fastening of the anti-submarine sleeve 42, and recoil of the elastic band 46, around the anti-submarine belt 2 substantially closes off the anti-submarine aperture 38 around the anti-submarine belt 2, thereby limiting passage of spilled food and drink through the anti-submarine aperture 38 to the seat 12 beneath.

Grab the left outside edge of the flap of material located between the left shoulder split 52 and the left lap split 58 and fold it forward across towards the other side of the seat cover 8 in order to gain access to the joined left lap and shoulder belts, 20 & 16 respectively.

Reach through the gap formed by folding of the flap and pull the joined left lap and shoulder belts forward through the gap.

Whilst holding the joined left lap and shoulder belts forward, fold the flap of material back behind the belt and to its original position so that the left shoulder belt 16 projects forward through the left shoulder aperture 34, the left lap belt 20 projects forward through the left lap aperture 36, and the left shoulder and lap belts are joined in front of the flap of material.

Close the left shoulder split 52 by fastening together hooked and looped portions, 54 and 56 respectively, of the shoulder split Velcro fastener (see arrows 148 in FIG. 8 indicating closure of shoulder splits 52).

Close the left lap sleeve 40 around the left lap belts 20, fastening together hooked and looped portions of the left lap sleeve Velcro fastener, 48 and 50 respectively. The fastening of the left lap sleeve 40, and recoil of the left elastic band 46, around the left lap belt 20 substantially closes off the left lap aperture 36 around the left lap belt, thereby limiting passage of spilled food and drink through the left lap aperture 36 to the seat 12 beneath.

Close the left lap split 58 by fastening together hooked and looped portions of the left lap split Velcro fastener, 60 and 62 respectively.

Repeat steps 7 to 12 above for the right side.

With the seat cover 8 fitted the child 6 may be sat and fastened in to the safety seat. Otherwise, if the seat cover 8 is to be used in conjunction with the harness cover 10, the harness cover 10 may now be fitted to the five point safety harness 14.

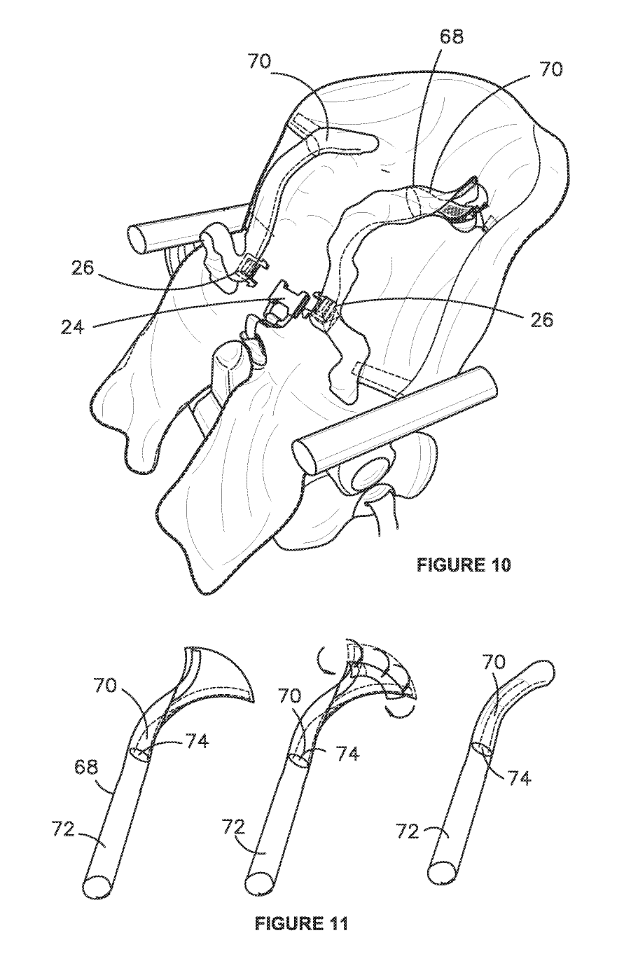

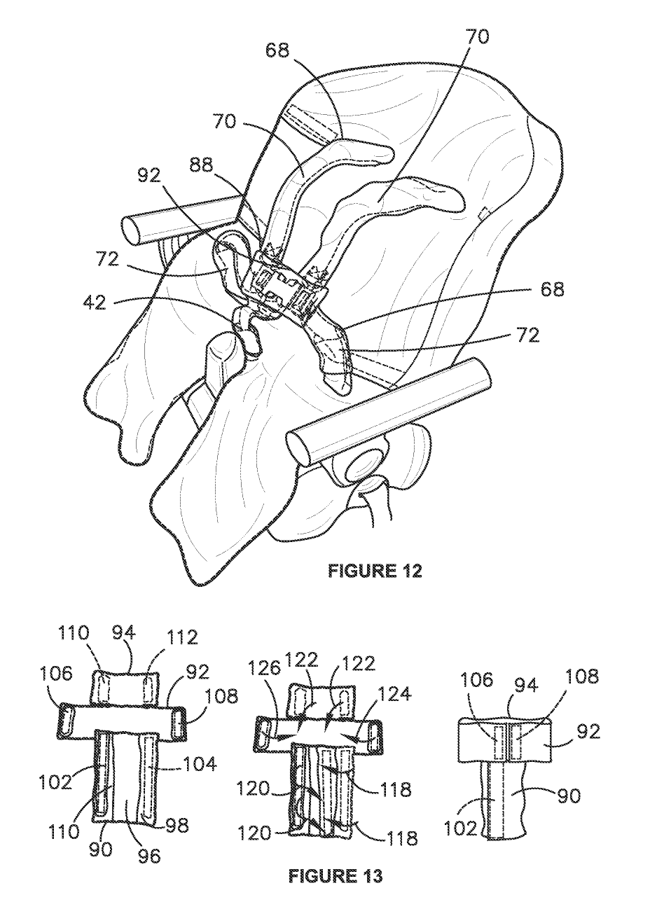

Referring now to FIGS. 10 to 13, the harness cover 10 may be fitted to the five point safety harness 14 in the following manner:

Place the rear surface of the central strip 76 of the left elongate sleeve 68 in front of the joined left shoulder and lap belts, 16 and 20 respectively, and the left lap sleeve 40 of the seat cover 8 (if fitted).

Thread the left adjustment buckle 26 forward through opening 74 so that the central strip 76 of the shoulder portion 70 of the left elongate sleeve 68 is arranged in front of the left shoulder belt 16 and the lap portion 72 is arranged in front of the left lap belt 20 and the left lap sleeve 40 of the seat cover 8 (if fitted).

Adjust the length of the left elongate sleeve 68 if and as required so that the shoulder portion 70 is about the same length as the left shoulder belt 16 and the lap portion 72 is about the same length as the left lap belt 20. As illustrated in FIG. 11, the length of the elongate sleeve 68 is adjusted by folding one or both ends of the sheet of the sleeve flatly back over themselves as required.

Fold strip 80 of the left elongate sleeve 68 behind the joined left shoulder and lap belts, 16 & 20 respectively, and the left lap sleeve 40 of the seat cover 8 (if fitted).

Fold strip 78 of the left elongate sleeve 68 behind the folded strip 80 and fasten the hooked material 82 of the strip 78 to the looped material 84 of the strip 80, thereby holding the left elongate sleeve 68 closed around the joined left shoulder and lap belts, 16 and 20 respectively, and the left lap sleeve 40 of the seat cover 8 (if fitted). Closing the elongate sleeve around the left lap sleeve of the seat cover may be of particular importance when using the seat cover version without elasticised sleeves as it closes off food access to the left lap aperture of the seat cover, thereby limiting food from passing through the left aperture and beneath the seat cover on to the seat.

Repeat steps 1 to 5 for the right side.

Pull the anti-submarine belt 22 taught.

Place the rear surface of the central strip 96 of the anti-submarine sleeve 90 of the middle piece 88 in front of the anti-submarine belt 22 and the anti-submarine sleeve 42 of the seat cover 8 (if fitted), with the junction clasp 24 projecting above the top of the anti-submarine sleeve 90.

Adjust the length of the anti-submarine sleeve 90 if and as required so that it is about the same length as the anti-submarine belt 22. The length of the anti-submarine sleeve 90 is adjusted by folding the bottom end of the flat sheet of the sleeve flatly back on itself.

Fold strip 98 (as indicated by arrow 118 in FIG. 13) of the anti-submarine sleeve 90 behind the anti-submarine belt 22 and the anti-submarine sleeve 42 of the seat cover 8 (if fitted).

Fold strip 100 (as indicated by arrow 120 in FIG. 13) of the anti-submarine sleeve 90 behind the folded strip 98 and fasten the hooked material 102 of the strip 100 to the looped material 104 of the strip 98, thereby holding the anti-submarine sleeve 90 closed around the anti-submarine belt 22 and the anti-submarine sleeve 42 of the seat cover 8 (if fitted). Closing the elongate sleeve around the anti-submarine sleeve of the seat cover may be of particular importance when using the seat cover version without elasticised sleeves as it closes off food access to the anti-submarine aperture of the seat cover, thereby limiting food from passing through the anti-submarine aperture and beneath the seat cover on to the seat.

Sit child 6 in the safety seat 4.

Fasten the five point safety harness 14 around the child 6 by clipping heads 30 of the left and right adjustment buckles 26 into opposite sides of the junction clasp 24.

Arrange the wrap strip 92 of the middle piece 88 in front of the junction clasp and then fold the overlap segment 94 (as indicated by arrow 122 in FIG. 13) of the middle piece 88 down behind the junction clasp 24.

Wrap the left end of the wrap strip 92 (as indicated by arrow 124 in FIG. 13) around behind the junction clasp 24, fastening the hooked material 106 to the looped material 110 of the overlap segment 94. Similarly, wrap the right end of the wrap strip 92 (as indicated by arrow 126 in FIG. 13) around behind the junction clasp 24, fastening the hooked material 108 to the looped material 112 of the overlap segment 94. This substantially closes off the junction clasp 24 and connected elements from spillage.

The harness cover 10 may also be fitted for use in isolation, without the seat cover 8.

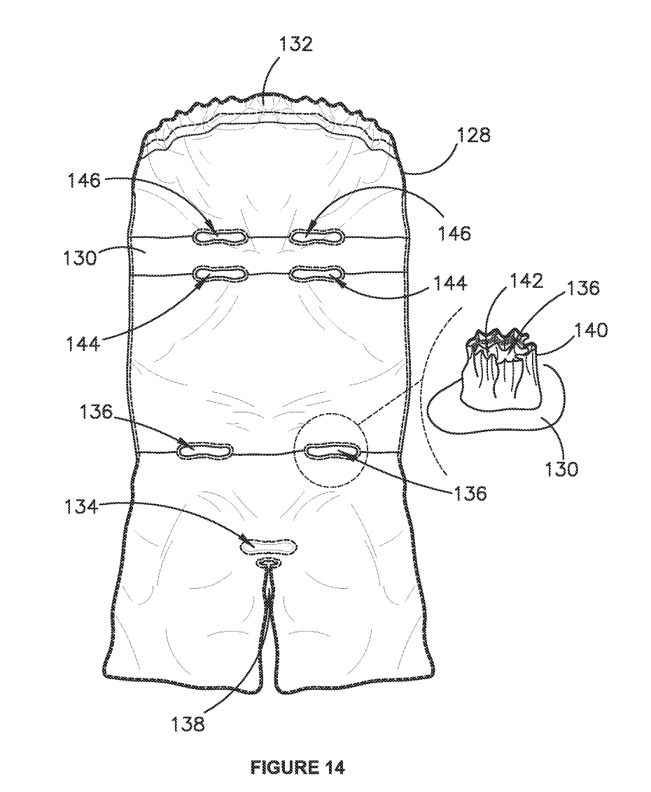

FIG. 14 shows an alternative seat cover 128, which may be used instead of seat cover 8. Like seat cover 8, seat cover 128 comprises a main sheet 130 with an elasticised pouch 132, an anti-submarine aperture 134, a pair of lap apertures 136, and a notch 138. An anti-submarine sleeve (not visible) projects forward from the front surface of the seat cover 128 and surround the anti-submarine aperture 134 and a pair of lap sleeves 140 (left lap sleeve shown in inset of FIG. 14) projects forward from the front surface of the seat cover 128 and surrounds respective lap apertures 136. The anti-submarine and lap sleeves are closed tubes which are unable to be unfastened. They each have a circular elastic band 142 for closing off their respective apertures around respective belts. The seat cover 128 further comprises upper and lower pairs of shoulder apertures, 146 and 144 respectively. Having upper and lower shoulder apertures allows the seat cover 128 to be fitted on various sized safety seats with shoulder belts emerging at different heights. There are no lap and shoulder splits present in the alternative seat cover. Therefore all belts of the five point safety harness 14 should be disconnected prior to fitting so that each belt can be individually threaded through its associated aperture in the seat cover 8. Once the belts have been threaded through their associated apertures in the cover, the elasticised sleeves surrounding the lap and anti-submarine apertures will automatically recoil and close around their associated belts.

Whilst the above description includes the preferred embodiments of the invention, it is to be understood that many variations, alterations, modifications and/or additions may be introduced into the constructions and arrangements of parts previously described without departing from the essential items or the spirit or ambit of the invention.

It will be also understood that where the word “comprise”, and variations such as “comprises” and “comprising”, are used in this specification, unless the context requires otherwise such use is intended to imply the inclusion of a stated item or items but is not to be taken as excluding the presence of another item or items.

The reference to any prior art in this specification is not, and should not be taken as, an acknowledgement or any form of suggestion that such prior art forms part of the common general knowledge in Australia.

What is claimed is:

1. A cover for a seat and a safety harness, the safety harness including a pair of shoulder belts, a pair of lap belts, and at least one anti-submarine belt, the seat cover comprising,
a first pair of shoulder apertures for receiving respective shoulder belts therethrough,
a pair of lap apertures for receiving respective lap belts therethrough, and
an anti-submarine aperture for receiving the at least one anti-submarine belt therethrough.
wherein the said seat cover is removable, and the said lap, anti-submarine, and shoulder apertures include closing means for substantially preventing the ingress of spillage and/or bodily fluids into the said aperture around a respective lap and/or submarine belt and/or shoulder belt.

2. The seat cover as claimed in claim 1 wherein the seat cover comprises more than one pair of shoulder apertures located above or below the said first pair of shoulder apertures, thereby allowing the seat cover to be suitably fitted on various seats, each of which may have a pair of shoulder belts beginning at a different height or level, and/or making the cover more adaptable and adjustable to suit the needs of a growing child.

3. The seat cover as claimed in claim 2 wherein the closing means comprises an elastic band adapted to recoil and substantially close off its respective aperture, and the said closing means is incorporated into a substantially tubular shaped sleeve, and the said elastic band lines the sleeve.

4. The seat cover as claimed in claim 3 wherein the said sleeve includes fastening means for releasably joining ends or edges of the sleeve to form the said substantially tubular shape.

5. The seat cover as claimed in claim 4 wherein the said seat cover comprises a plurality of splits extending from the peripheral edges of the cover to one each of the shoulder, anti-submarine, or lap apertures or sleeves respectively, and each said split includes fastening means for releasably closing the split.

6. The seat cover as claimed in claim 5 wherein each said split communicates with, or is continuous with, one of the shoulder, anti-submarine or lap apertures, and when the split fastening means is unfastened it communicates with, or is continuous with, one of the shoulder, anti-submarine or lap apertures when their respective sleeve is unfastened.

7. The seat cover as claimed in claim 6 wherein the seat cover is padded, waterproof, machine washable and re-usable, or disposable.

8. A cover for a seat and a safety harness, the safety harness including a pair of shoulder belts, a pair of lap belts, and at least one anti-submarine belt, and a junction region where the shoulder and/or lap belts connect with anti-submarine belt when the harness is fastened, the safety harness cover comprising,
a pair of shoulder members for enclosing respective shoulder belts along the majority of their length,
a pair of lap members for enclosing respective lap belts along the majority of their length,
an anti-submarine member for enclosing the anti-submarine belt along the majority of its length, and
a junction member for enclosing the junction region between the respective shoulder, lap and anti-submarine belts.
wherein each said shoulder, lap and anti-submarine member comprises, or is adapted to form, a sleeve, and the sleeve adapted to receive a respective belt therethrough.

9. The harness cover as claimed in claim 8 wherein the said shoulder, lap and anti-submarine sleeves each comprise a substantially tubular shape, and the said sleeves further comprise fastening means for releasably fastening the ends or edges of each respective sleeve to form a substantially tubular shape, and unfastening the respective fastening means enables separation of the ends or edges of the relevant sleeve.

10. The harness cover as claimed in claim 9 wherein each shoulder, lap and anti-submarine member comprises a central strip bordered on each side by a pair of foldable strips, and the said foldable strips are adapted to fold along their borders in front of, or behind, the central strip, and overlap each other, in which position they are releasably fastenable together to create a flat tubular sleeve.

11. The harness cover as claimed in claim 10 wherein each said member is adapted to enclose a respective said sleeve of the said seat cover when installed, in which the said members forms part of the closing means of the said seat cover, being adapted to close off access to its respective said aperture.

12. The harness cover as claimed in claim 11 wherein each shoulder belt is connected to a respective lap belt, and wherein each shoulder member is joined to, or is continuous with, a respective lap member, thereby forming an elongate member, such that the said elongate member comprises the said shoulder member and the said lap member, and the said elongate member includes fastening means to releasably fasten the said member into an elongate substantially tubular shaped sleeve.

13. The harness cover as claimed in claim 12 wherein the said elongate sleeve is adapted to receive one of the shoulder belts and one of the lap belts therein.

14. The harness cover as claimed in claim 13 wherein the said elongate sleeve comprises an opening between the said shoulder member and the said lap member, and the opening is adapted to receive the ends of the shoulder and lap belts, or part of a buckle to which those ends are fastened, therethrough the said opening, and the said opening includes a buckle fastener at the level of the opening which interengages with the buckle to releasably retain it in place with respect to the cover, and prevent it from sliding into the said tube, or behind the cover.

15. The harness cover as claimed in claim 14 wherein the said junction member comprises a wrap strip adapted to wrap at least partially around the said junction region, and the said wrap strip is adapted to wrap at least partially around the junction region when the harness is fastened, thereby the said wrap strip wraps around the bottom ends of respective said shoulder belts, with the remaining portions of the shoulder belts projecting out above the wrapped wrap strip, and the said wrap strip wraps around the top ends of respective lap belts, with the remaining portions of the lap belts projecting out below the wrapped wrap strip.

16. The harness cover as claimed in claim 15 wherein the said wrap strip comprises a strip fastener, and the strip fastener is present at one or both ends of the said strip, and the strip fastener is adapted to hold the said wrap strip wrapped, at least partially around the junction region.

17. The harness cover as claimed in claim 16 wherein the said junction member comprises an overlap segment, and the overlap segment is attachable to, or continuous with, the wrap strip, and an edge of the overlap segment is attachable to the top lengthwise border of the wrap strip, and the overlap segment is adapted to wrap over in front of or behind the junction region.

18. The harness cover as claimed in claim 17 wherein the said overlap segment comprises a segment fastener, and the said segment fastener is present at one or both ends of the said overlap segment, and the said segment fastener is adapted to fasten the said overlap segment to one or both ends of the said wrap strip when the wrap strip is wrapped at least partially around the said junction region.

19. The harness cover as claimed in claim 18 wherein the said harness cover is removable, water proof, comprises shock absorbing material and/or padding, and is machine washable and reusable, or disposable.

20. A cover for a seat and a safety harness, the safety harness including a pair of shoulder belts, a pair of lap belts, and at least one anti-submarine belt, and a junction region where the shoulder belts connect with anti-submarine belt when the harness is fastened, the safety harness cover comprising,
a pair of shoulder members for enclosing respective shoulder belts along the majority of their length,
an anti-submarine member for enclosing the anti-submarine belt along the majority of its length, and
a junction member for enclosing the junction region.
Such that when used in conjunction, the said harness cover and the seat cover substantially covers the seat and the safety harness respectively, thereby substantially preventing the ingress of spillage, debris and/or bodily fluids on to the seat and safety harness.
